(19) United States
(12) Patent Application Publication
(10) Pub. No.: US 2021/0128284 A1
(43) Pub. Date: May 6, 2021

(54) MISSING TOOTH SUPPLEMENTING DENTAL PROSTHESIS

(71) Applicant: Si Ho KIM, Jecheon-si (KR)

(72) Inventor: Si Ho KIM, Jecheon-si (KR)

(21) Appl. No.: 16/963,215

(22) PCT Filed: Jan. 23, 2019
(86) PCT No.: PCT/KR2019/000960

§ 371 Date: Jul. 18, 2020

(30) Foreign Application Priority Data
Feb. 12, 2018 (KR) 10-2018-0017010

(51) Int. Cl. A61C 13/225; A61C 13/271

(52) U.S. Cl. CPC A61C 13/2255; A61C 13/26

(57) ABSTRACT

The present invention relates to a missing tooth supplementing dental prosthesis that may provide the best wearing comfort regardless of the condition of a user's gums as the height of an end of a missing tooth supplementing member is adjusted according to the condition of the user's gums. The present disclosure proposes a missing tooth supplementing dental prosthesis including: a prosthetic body configured to be detachably worn in the oral cavity of a user who has at least one missing tooth, and provided with a fastening portion that is formed in a portion corresponding to a missing tooth; and a missing tooth supplementing member configured to be height-adjustably coupled to the fastening portion of the prosthetic body, to be height-adjusted according to the condition of the user's gums, and to supplement the missing tooth as an embodiment.

### TECHNICAL FIELD

The present disclosure relates to a dental prosthesis that is worn in an oral cavity to replace a missing tooth, such as dentures, partial dentures, or a removable tooth protector.

### BACKGROUND ART

Unless otherwise indicated in this specification, the technologies described in this section are not prior art to the claims of the present application, and the descriptions given in this section are not intended to admit that they correspond to prior art.

In general, persons have a total of 32 teeth including 16 teeth in the upper jaw and 16 teeth in the lower jaw. As the milk teeth generated during infancy enter a growth phase, they are replaced with permanent teeth, and oral activities are performed using the permanent teeth throughout their life.

In the case where one or more teeth are damaged due to oral disease, such as tooth decay, after the formation of permanent teeth, a missing tooth supplementing dental prosthesis is worn to supplement an insufficient chewing function.

A missing tooth supplementing dental prosthesis restores a function by supplementing a missing tooth with an artificial tooth (a denture) for the large parenchymal loss of the tooth, the deterioration of an oral function attributable to the mission of the tooth, or an abnormality in shape. Examples of a missing tooth supplementing dental prosthesis include dentures, partial dentures, and removable dental protectors.

As an example of a missing tooth supplementing dental prosthesis, in Korean Patent Application Publication No. 10-2015-0029117 (published on Mar. 18, 2015), there is disclosed a removable denture, including a coupling portion having a groove into which gums are inserted, a denture body having at least one artificial tooth arranged along the upper side of the coupling portion, and an elastic member embedded along the lower end of the coupling portion so that the coupling portion is elastically coupled to the gums.

Furthermore, in Korean Utility Model Registration No. 20-0183838 (published on Jun. 1, 2000), there is disclosed a partial denture fastening structure that in the construction of a partial denture including an artificial tooth and a denture base using metal or ceramic and synthetic resin for the appropriate restoration of a wide-tooth defect area,

The denture is formed at both side edges or one end so that the lower portion thereof is formed to penetrate and the upper portion thereof forms a channel-shaped recess to have a constant thickness, an adjacent tooth to which the denture is fastened has an insertion hole for mounting an inlay, including an insertion portion configured to have an approximate sideways “H” shape and to be fastened to the denture recess and a fastening portion formed by providing a plurality of protrusions fastened to the adjacent tooth with a constant angle in a downward direction, and the insertion hole fastens the denture while forming a constant downward inclination with respect to the horizontal surface of the tooth.

Furthermore, in Korean Patent No. 10-1682422 (published on Nov. 8, 2016), there is disclosed a removable tooth protector in which a cover body extends in an integrated form and is provided to cover the surfaces of the teeth from the molars to the front teeth, the cover body is configured to cover the occlusal and tongue surfaces for the molars and cover the tongue surfaces for the canine and the front teeth, when the occlusal surface of the tooth and the surface of the cover body in contact with the tongue surface is defined as the inner surface, the inner surface is formed to conform to the shapes of the occlusal and tongue surfaces, and the outer surface corresponding to the thickness from the inner surface is also formed to conform to the shapes of the occlusal and tongue surfaces, thereby enhancing wearing comfort and facilitating a chewing action, the cover body is provided with a detachable fastener configured to be attached to and detached from a tooth, and the detachable fastener is formed to extend to fit into the boundary between the tooth and the gums, and securely maintains an attached state when the removable tooth protector is worn on the tooth, thereby ultimately preventing food from clogging up when chewing the food and protecting a specific tooth.

In the case of the above-described conventional missing tooth supplementing dental prostheses, they are simply provided to a user in a state adjusted to be easily and beautifully detachable in the user's mouth, and it is configured to be detached as it is. However, during use, it cannot be adjusted according to the condition of the user's oral cavity, especially the condition of the gums. Therefore, when a user's gums are swollen, a problem arises in that wearing comfort is deteriorated.

### DISCLOSURE

### Technical Problem

The present invention is intended to provide a missing tooth supplementing dental prosthesis that may provide the best wearing comfort regardless of the condition of a user's gums as the height of an end of a missing tooth supplementing member is adjusted according to the condition of the user's gums.

Furthermore, technical problems of the present invention are not limited to the above-described technical problem, and it is obvious that another technical problem may be derived from the following description.

### Technical Solution

The present disclosure proposes a missing tooth supplementing dental prosthesis including: a prosthetic body configured to be detachably worn in the oral cavity of a user who has at least one missing tooth, and provided with a fastening portion that is formed in a portion corresponding to a missing tooth; and a missing tooth supplementing member configured to be height-adjustably coupled to the fastening portion of the prosthetic body, to be height-adjusted according to the condition of the user's gums, and to supplement the missing tooth as an embodiment.

According to a preferred feature of the present disclosure, the fastening portion may be formed on a supplementary member coupling element that is detachably coupled to the portion of the prosthetic body corresponding to the missing tooth.

### Advantageous Effects

The missing tooth supplementing dental prosthesis according to the present disclosure is advantageous in that as it is configured in a structure in which the missing tooth supplementing member is height-adjustably coupled to the fastening portion of the prosthetic body, the missing tooth supplementing dental prosthesis is worn in a user's oral cavity with the height of an end of the missing tooth supplementing member that comes into contact with the gums being adjusted according to the condition of the user's gums, thereby providing the best wearing comfort regardless of the condition of the user's gums.

The effects of the present invention are not limited to the effects mentioned above, and other effects not mentioned will be clearly understood by those skilled in the art from the description of the claims.

### DESCRIPTION OF DRAWINGS

FIG. 1 is a partially exploded perspective view of a missing tooth supplementing dental prosthesis according to an embodiment of the present disclosure;

FIG. 2 is an operational sectional view of the missing tooth supplementing dental prosthesis according to the embodiment of the present disclosure;

FIG. 3 is a partial exploded perspective view of a missing tooth supplementing dental prosthesis according to another embodiment of the present disclosure; and

FIG. 4 is an operational sectional view of the missing tooth supplementing dental prosthesis according to the other embodiment of the present disclosure.

### DESCRIPTION OF REFERENCE SYMBOLS OF IMPORTANT PARTS IN THE DRAWINGS

1: missing tooth supplementing dental prosthesis
10: prosthetic body
10a: metal surface
11: supplementary member coupling element
13: fastening portion
15: coupling clip
17: elastic connection portion
20: missing tooth supplementing member
21: corresponding fastening portion

### MODE FOR INVENTION

The configuration, operation and operational effect of a missing tooth supplementing dental prosthesis according to a preferred embodiment will be described in detail below with reference to the accompanying drawings. For reference, in the following drawings, each component will be omitted or schematically illustrated for the purposes of convenience and clarity, and the size of each component does not reflect the actual size thereof. Furthermore, the same reference numerals refer to the same components throughout the specification, and reference numerals for the same components in the individual drawings will be omitted.

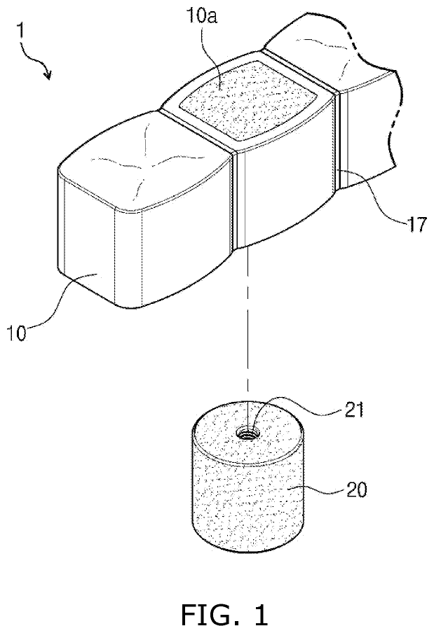

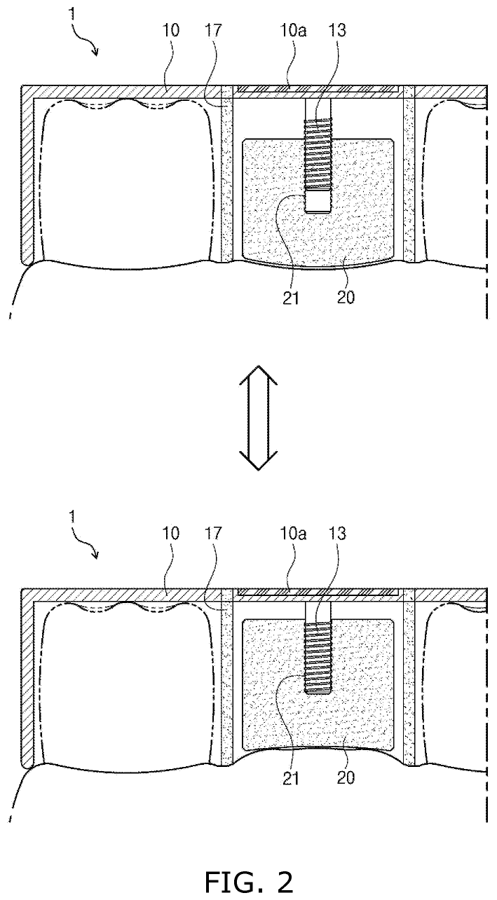

FIG. 1 is an exploded perspective view of a missing tooth supplementing dental prosthesis according to an embodiment of the present disclosure, and FIG. 2 is an operational sectional view of the missing tooth supplementing dental prosthesis according to the embodiment of the present disclosure.

The missing tooth supplementing dental prosthesis 1 according to the embodiment of the present disclosure is detachably worn in the oral cavity of a user who has at least one missing tooth, and serves to restore functions by supplementing the missing tooth for the deterioration of an oral function and the abnormality of the shape of the oral cavity due to the mission of a tooth.

As shown in FIGS. 1 and 2, the missing tooth supplementing dental prosthesis 1 according to the embodiment of the present disclosure includes: a prosthetic body 10 configured to be detachably worn in the oral cavity of a user who has at least one missing tooth, and provided with a fastening portion 13 that is formed in a portion corresponding to a missing tooth; and a missing tooth supplementing member 20 configured to be height-adjustably coupled to the fastening portion 13 of the prosthetic body 10, to be height-adjusted according to the condition of the user's gums, and to supplement the missing tooth.

In this case, the prosthetic body 10 is detachably worn in the oral cavity of a user who has at least one tooth, and functions to protect the tooth or supplement the function of the tooth.

The prosthetic body 10 has a cross-section in an inverted “U” shape as a whole to cover a teeth portion including a missing tooth and extend to the gums. Furthermore, although the prosthetic body 10 is shown in the form of a removable tooth protector, it may be formed as dentures or partial dentures.

Furthermore, the prosthetic body 10 may be formed to be worn on at least three teeth including a missing tooth and two teeth on the left and right sides of the missing tooth, respectively. In an embodiment, it may be formed to be worn on overall upper or lower teeth.

The fastening portion 13 is formed in the portion of the prosthetic body 10 corresponding to a missing tooth. The fastening portion 13 corresponds to a coupling portion to which the missing tooth supplementing member 20 to be described later is height-adjustably coupled.

The fastening portion 13 may be formed in the form of a male thread rod, as shown in the drawing, so that particularly the missing tooth supplementing member 20 is height-adjustably coupled to the fastening portion 13 through screwing. Although not shown in the drawing, it may also be formed in the form of a female thread groove.

The prosthetic body 10 may be made of, for example, synthetic rubber, synthetic resin such as silicone, metal material such as tin alloy, titanium alloy or stainless steel, or a combination thereof.

For example, the prosthetic body 10 is made of synthetic rubber, synthetic resin material such as silicone, or the like as a whole. The metal surface 10a, such as a surface made of stainless steel or titanium alloy, may be formed only in a top surface forming a chewing surface in an integrated manner. In this case, the metal surface 10a may be formed only in the top surface of the portion of the top surface of the prosthetic body 10 corresponding to a missing tooth.

Furthermore, the prosthetic body 10 is formed of a rigid material as a whole, and an elastic connection portion 17 formed of an elastic material may be interposed between adjacent tooth insertion portions so as to be adjustable to correspond to a user's dental structure.

The missing tooth supplementing member 20 is coupled to the fastening portion 13 that is formed in the portion of the above-described prosthetic body 10 corresponding to a missing tooth. The missing tooth supplementing member 20 serves to supplement the missing tooth by filling the corresponding portion of the missing tooth, and may be made of a material used for an artificial tooth (denture) or, in an embodiment, may be made of the same material as the prosthetic body 10.

The missing tooth supplementing member 20 is height-adjustably coupled to the fastening portion 13 of the prosthetic body 10 so that the height of the end of the missing tooth supplementing member 20 that comes into contact with a user's gums can be adjusted to correspond to the condition of the user's gums.

The corresponding fastening portion 21 formed in the missing tooth supplementing member 20 may be formed in the shape of a female screw groove so as to be height-adjustably coupled to the male thread fastening portion 13 of the prosthetic body 10 by screwing. Alternatively, in an embodiment, although not shown in the drawing, the corresponding fastening portion 21 formed on the missing tooth supplementing member 20 may be formed in the shape of a male thread rod so as to be height-adjustably coupled to the female thread groove-shaped fastening portion 13 of the prosthetic body 10 through screwing

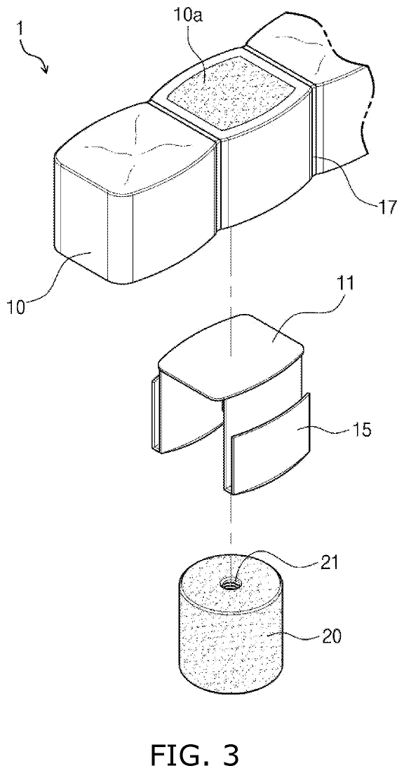

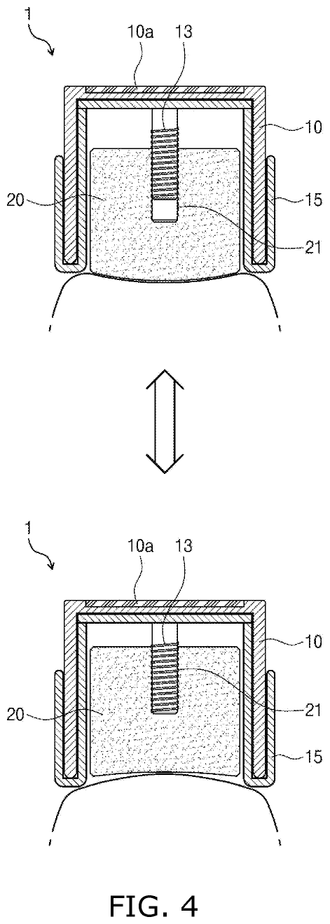

FIG. 3 is a partial exploded perspective view of a missing tooth supplementing dental prosthesis according to another embodiment including a supplementary member coupling element 11, and FIG. 4 is an operational sectional view of the missing tooth supplementing dental prosthesis according to the other embodiment including the supplementary member coupling element 11.

Although the fastening portion 13 to which the above-described missing tooth supplementing member 20 is coupled may be formed directly on the portion of the inside of the prosthetic body 10 corresponding to a missing tooth, as shown in FIGS. 1 and 2, the fastening portion 13 may be formed on the supplementary member coupling element 11 that is detachably coupled to the portion of the inside of the prosthetic body 10 corresponding to a missing tooth in an embodiment, as shown in FIGS. 3 and 4.

Although the supplementary member coupling element 11 may be coupled to the portion of the inside of the prosthetic body 10 corresponding to a missing tooth by various methods such as press-fitting, bonding, etc., fastening clips 15 configured to be fitted into the front and rear walls of the prosthetic body 11 are preferably provided in the front and rear sides of the supplementary member coupling element 11 so that the supplementary member coupling element 11 is detachably coupled to the portion of the inside of the prosthetic body 10 corresponding to a missing tooth, as shown in FIGS. 3 and 4.

Furthermore, the supplementary member coupling element may be coupled to the portion of the inside of the prosthetic body 10 corresponding to a missing tooth by various detachable coupling means such as magnets in addition to the coupling clips 15.

As the missing tooth supplementing dental prostheses 1 according to the embodiments of the present disclosure are formed in a structure in which the missing tooth supplementing member 20 is height-adjustably coupled to the fastening portion 13 of the prosthetic body 10, the missing tooth supplementing dental prostheses 1 are each worn in a user's oral cavity with the height of the end of the missing tooth supplementing member 20 that comes into contact with the gums being adjusted according to the condition of a user's gums, as shown in FIGS. 2 and 4, thereby providing the best wearing comfort regardless of the condition of the user's gums.

Although the preferred embodiments of the present invention have been described above with reference to the accompanying drawings, it should be understood that there may be various equivalents and modifications that can replace them at the time of application because the embodiments described in the specification and the configurations shown in the drawings are merely the most preferred embodiments of the present invention and do not represent the overall technical spirit of the present invention. Therefore, the above-described embodiments are to be understood as illustrative and not restrictive in all respects, the scope of the present invention is defined by the following claims rather than the detailed description, and it should be construed that the meanings and scopes of the claims and any alterations or modifications derived from equivalent concepts are included in the scope of the present invention.

### INDUSTRIAL APPLICABILITY

The present disclosure is applicable to dental prostheses worn in the oral cavity to replace missing teeth, such as dentures, partial dentures, and removable tooth protectors.

1. A missing tooth supplementing dental prosthesis comprising:
a prosthetic body configured to be detachably worn in an oral cavity of a user who has at least one missing tooth, and provided with a fastening portion that is formed in a portion corresponding to a missing tooth; and
a missing tooth supplementing member configured to be height-adjustably coupled to the fastening portion of the prosthetic body, to be height-adjusted according to a condition of the user's gums, and to supplement the missing tooth.

2. The missing tooth supplementing dental prosthesis of claim 1, wherein the fastening portion is formed on a supplementary member coupling element that is detachably coupled to the portion of the prosthetic body corresponding to the missing tooth.

3. The missing tooth supplementing dental prosthesis of claim 2, wherein coupling clips configured to be fitted into the prosthetic body are provided on a front and rear of the supplementary member coupling element.

4. The missing tooth supplementing dental prosthesis of claim 1, wherein the missing tooth supplementing member is coupled to the fastening portion of the prosthetic body through screwing via a corresponding fastening portion so that a height of the missing tooth supplementing member is adjusted according to the condition of the user's gums.

5. The missing tooth supplementing dental prosthesis of claim 1, wherein the prosthetic body is one of dentures, partial dentures, and a removable tooth protector.
